(19) United States
(12) Patent Application Publication
(10) Pub. No.: US 2010/0193076 A1
(43) Pub. Date: Aug. 5, 2010

(54) CAPLESS FUEL TANK FILLER PIPE ASSEMBLY

(76) Inventors: Paul D. Walkowski, Ann Arbor, MI (US); Robert P. Benjey, Dexter, MI (US); Kenneth Maynard Spink, Horton, MI (US)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 12/363,405

(22) Filed: Jan. 30, 2009

(51) Int. Cl. B60K 15/04; B65B 1/04

(52) U.S. Cl. 141/348; 220/86.2

(57) ABSTRACT

A capless fuel tank filler pipe assembly includes a filler pipe and a bulkhead disposed on the filler pipe. The bulkhead includes a nozzle receiving portion. A flapper door is pivotally disposed on the filler pipe, and is biased to a closed position. The flapper door is configured to compress an annular seal disposed between the bulkhead and the flapper door. The annular seal includes a liquid/vapor sealing material bonded to a substantially impermeable material. The substantially impermeable material substantially blocks emission of hydrocarbon molecules that permeate the liquid/vapor sealing material.

### BACKGROUND

The present disclosure relates generally to a capless fuel tank filler pipe assembly and to a method of sealing a capless fuel tank filler pipe assembly.

Fuel systems, including those used in motorized vehicles, generally include a fuel tank in fluid connection with a filler pipe assembly. The filler pipe assembly often includes a bulkhead disposed on the filler pipe and a flapper door pivotally disposed on the filler pipe. The bulkhead may include a nozzle receiving portion defined therein. Such fuel tanks may be filled by dispensing a fuel (e.g., gasoline, diesel, or the like) into the tank through the nozzle receiving portion of the filler pipe assembly, and allowing the fuel to travel through the filler pipe into the tank. In some instances, the filler pipe assembly may be sealed with a user removable cap. However, consumers may inadvertently not replace the cap after refueling, or may improperly replace it, resulting in potential emission of liquid fuel or fuel vapor into the environment.

Capless fuel tank filler pipe assemblies, for example in U.S. Pat. No. 6,155,316 (incorporated herein by reference), provide solutions to some of the problems above. Because regulatory bodies are reducing the allowable amounts of hydrocarbon released into the atmosphere, prevention of liquid and vapor leaks is insufficient. New regulations, for example United States PZEV requirements, have reduced the allowable emissions to such an extent that permeation through fuel system seals may significantly affect the ability of a vehicle to meet the requirement.

Current capless fuel tank filler pipe assembly seals compromise between elastomers with low permeability and elastomers with good liquid/vapor sealing capability. Liquid/vapor sealing capability depends on factors like durometer, surface texture, surface durability, and resilience. Some materials that are relatively good at liquid/vapor seal and have relatively good permeability have relatively high cost. It would be desirable to have a capless fuel tank filler pipe assembly with a liquid/vapor seal using materials that are well suited to liquid/vapor sealing, while substantially preventing hydrocarbon emission through permeation.

### SUMMARY

A capless fuel tank filler pipe assembly includes a filler pipe and a bulkhead disposed thereon. The bulkhead includes a nozzle receiving portion. A flapper door is pivotally disposed on the filler pipe. The flapper door is biased to a closed position and is configured to compress an annular seal disposed between the bulkhead and the flapper door. The annular seal includes a liquid/vapor sealing material bonded to a substantially impermeable material. The substantially impermeable material substantially blocks emission of hydrocarbon molecules that permeate the liquid/vapor sealing material.

### BRIEF DESCRIPTION OF THE DRAWINGS

Features and advantages of embodiments of the present disclosure will become apparent by reference to the following detailed description and drawings, in which like reference numerals correspond to the same or similar, though perhaps not identical, components. For the sake of brevity, reference numerals having a previously described function may or may not be described in connection with subsequent drawings in which they appear.

FIG. 1 is a cross-sectional view of an embodiment of a capless fuel tank filler pipe assembly including an embodiment of an annular seal;

FIG. 1A is an enlarged view of a portion of the capless fuel tank filler pipe assembly of FIG. 1 including the annular seal;

FIGS. 2-8 are schematic cross-sectional views of other embodiments of the annular seal;

FIG. 9 is a schematic cross-sectional view of still another embodiment of the annular seal and a wear-stop band adjacent thereto;

FIG. 10 is a schematic cross-sectional view of an embodiment of a capless fuel tank filler pipe assembly including an embodiment of an annular seal;

FIG. 11 is a perspective view of a sphere depicting an example of a “zone;” and

FIG. 12 is a schematic cross-sectional view of another embodiment of a capless fuel tank filler pipe assembly including an embodiment of an annular seal.

### DETAILED DESCRIPTION

Embodiment(s) of the capless fuel tank filler pipe assembly as disclosed herein advantageously includes an annular seal that suitably seals the filler pipe such that fuel vapors from inside the fuel tank cannot escape into the atmosphere. The annular seal includes two materials, a liquid/vapor sealing material and a substantially impermeable material, bonded together. The two-material bonded annular seal advantageously provides both structural support and substantially prevents fuel vapors from permeating therethrough.

It is to be understood that, as used herein, the terms “permeability”, “permeation” or the like refer to the ability of molecules of one material to pass through another material by diffusion through the molecular structure of the other material. Permeability, permeation, etc. are distinguishable from leakage of fluid or vapor through pores, cracks and other similar voids.

It is also to be understood that, as used herein, the geometric term spherical “zone” refers to a surface of a spherical segment excluding the bases. A spherical zone is a surface of revolution about an axis of a sphere. As used herein, the surface may be an internal or external surface of the spherical segment. An example of a spherical zone is depicted in FIG. 11. In particular, FIG. 11 depicts a “zone” of a sphere of Radius R, the zone having a spherical segment with radii “b” and “a.” The height of the spherical segment is “h”. The bases, which are excluded from the zone, are the disks circumscribed by circles having radii “b” and “a.” The zone is a surface of revolution about the Z-axis, and the surface area is given by S=2πRh.

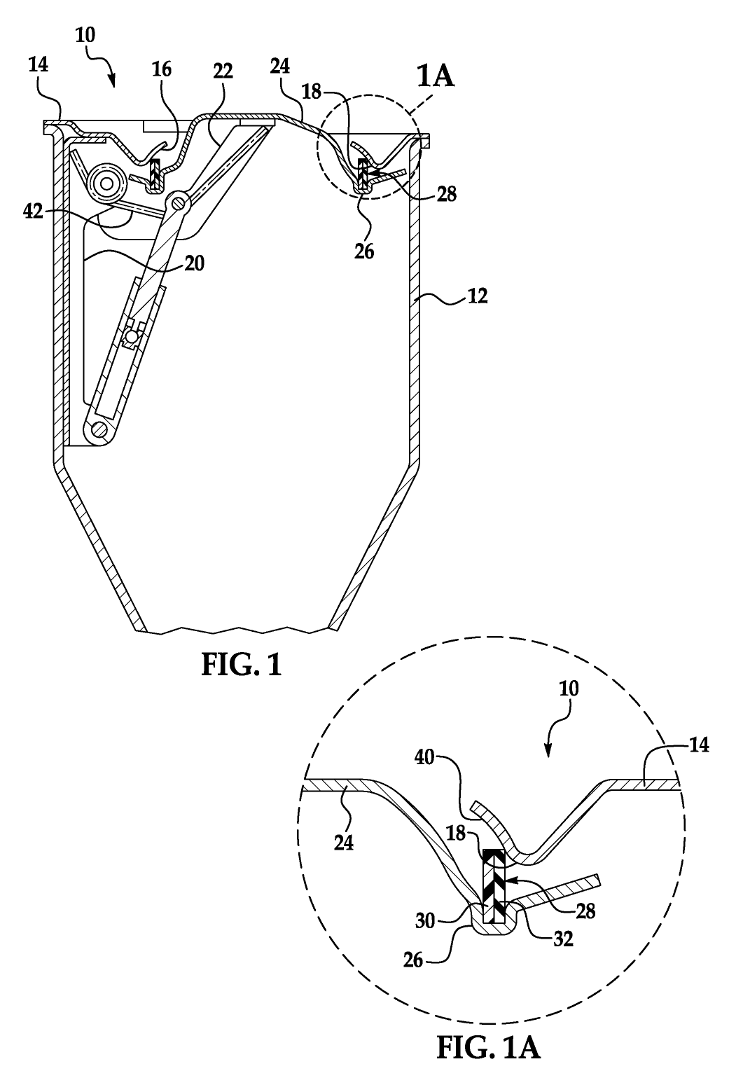

With reference now to the drawings, FIG. 1 depicts an embodiment of a capless fuel tank filler pipe assembly 10. Generally, the fuel tank filler pipe assembly 10 includes a filler pipe 12 having a bulkhead 14 disposed thereon. The bulkhead 14 includes a nozzle receiving portion 16 formed therein.

The filler pipe 12 includes a bracket 20 including a pivot arm 22 connected thereto. A flapper door 24 is pivotally disposed on the filler pipe 12 by connecting the flapper door 24 to an end of the pivot arm 22. The flapper door 24 includes an annular channel 26 formed therein. An annular flange 18 of the bulkhead 14 generally extends over at least a portion of the flapper door 24. An annular seal 28 is disposed between the bulkhead 14 and the flapper door 24. As shown in FIG. 1A, the annular seal 28 includes a portion 32 formed from a liquid/vapor sealing material bonded to another portion 30 formed from a substantially impermeable material. The liquid/vapor sealing material portion 32 may be bonded to the substantially impermeable material portion 30 via chemical bonding, mechanical bonding, or combinations thereof. As non-limiting examples, chemical bonding may be achieved by coextrusion, chemical adhesives, solvents, or combinations thereof. Non-limiting examples of mechanical bonding are crimping, overmolding, interlocking shapes or combinations thereof.

In an embodiment, the liquid/vapor sealing material for the portion 32 of the annular seal 28 is selected from a number of resilient sealing materials which provide a desirable amount of flexibility, deformability, and/or resilience to the seal 28. Generally, the liquid/vapor sealing material is sufficiently resilient to form a liquid/vapor seal when a closing force is applied to the flapper door 24. In a non-limiting example, the closing force is applied by a spring 42. It is to be understood that, generally, such structurally-strong resilient sealing materials may also be, at least partially, permeable to certain molecules (e.g., hydrocarbon molecules) present in fluids in contact therewith. Such fluids include, but are not limited to, gasoline and/or other fuels in either the gas or liquid states. Since the portion 32 functions as a seal for liquid and/or vapors, it is to be understood that the material selected should have a substantially low permeability. As used herein, the term “substantially low permeability” means that a seal formed from the material would allow hydrocarbon permeation of about 1 mg/day to about 3 mg/day when exposed to the vapor produced by a mixture of gasoline and 10 percent ethanol. Non-limiting examples of suitable materials for the liquid/vapor sealing material include fluorinated elastomers selected from vinylidene fluoride, hexafluoropropylene, tetrafluoroethylene perfluoromethylvinylether, and combinations thereof.

The permeation of hydrocarbon molecules through the selected, low permeable liquid/vapor sealing portion 32 of the annular seal 28 is undesirable, and the present inventors have found that the escape of such molecules can be substantially prevented by bonding a substantially impermeable material (i.e., the portion 30) to the liquid/vapor sealing material portion 32. The addition of the substantially impermeable portion 30 substantially reduces the exposure of the low permeable liquid/vapor sealing portion 32 to the atmosphere. Non-limiting examples of suitable substantially impermeable materials include acetal(polyoxymethylene), polyimide, polytetrafluoroethylene, steel, aluminum, and combinations thereof.

As provided above, and referring to FIGS. 1 and 1A, the annular seal 28 is disposed in the filler pipe assembly 10 between the bulkhead 14 and the flapper door 24. In an embodiment, the annular seal 28 is situated in the filler pipe assembly 10 such that at least a portion of the liquid/vapor sealing material 32 is compressed between the flapper door 24 and the bulkhead 14, thereby forming a liquid/vapor seal between the bulkhead 14 and the flapper door 24. The bulkhead 14 may include an annular seat 40 having a surface substantially defining a spherical zone that contacts the annular seal 28.

Without being bound to any theory, it is believed that the spherical zone annular seat provides enhanced sealing with greater tolerance to misalignment of the annular seal 28 than linear or simple curved sealing surfaces. In an embodiment, the annular seal 28 is crimped or otherwise disposed within the flapper door 24 to form a substantially liquid, vapor, and permeation proof joint between the annular seal 28 and the flapper door 24. It is further believed that limiting the total area of the liquid/vapor sealing material portion 32 that is exposed either to liquid/vapor within the filler pipe assembly 10, or to the atmosphere outside of the filler pipe assembly 10, will substantially prevent the emission of hydrocarbon molecules to the atmosphere due to permeation. In an embodiment, the area exposed to the atmosphere outside of the filler pipe assembly 10 is the edge of the liquid/vapor sealing material portion 32 between the substantially impermeable material portion 30 and the bulkhead 14. It is to be understood that the liquid/vapor sealing material portion 32 is at least partially compressed when the flapper door 24 is closed, thereby leading to an additional reduction in the area of the liquid/vapor sealing material portion 32 that is exposed to the atmosphere outside of the filler pipe assembly 10.

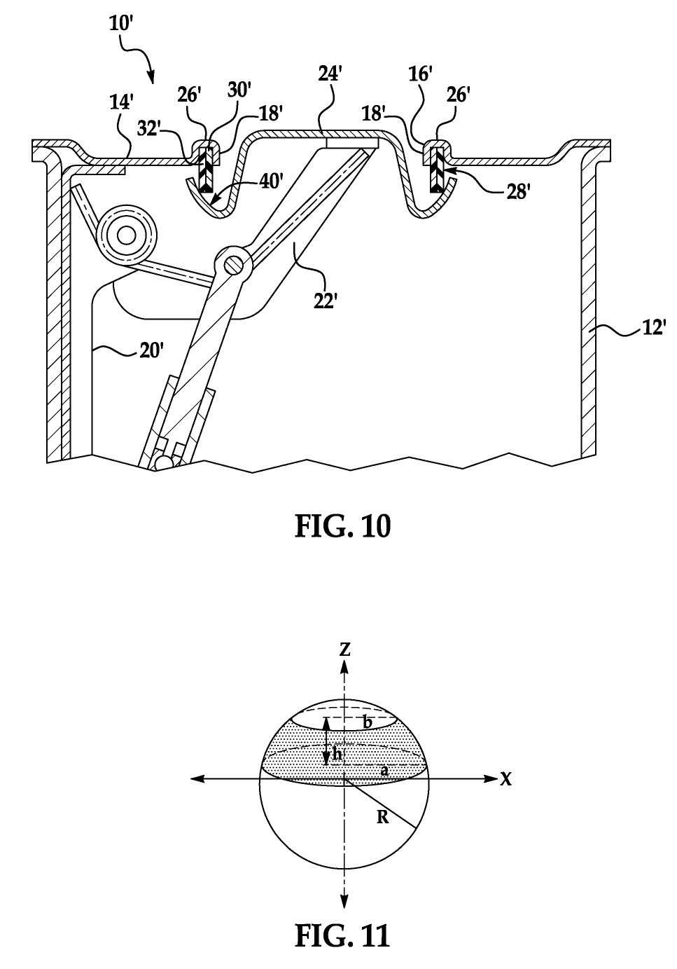

Referring now to FIG. 10, an embodiment of a capless fuel tank filler pipe assembly 10′ is shown. Generally, the fuel tank filler pipe assembly 10′ includes a filler pipe 12′ having a bulkhead 14′ disposed thereon. The bulkhead 14′ includes a nozzle receiving portion 16′ formed therein.

The filler pipe 12′ includes a bracket 20′ including a pivot arm 22′ connected thereto. A flapper door 24′ is pivotally disposed on the filler pipe 12′ by connecting the flapper door 24′ to an end of the pivot arm 22′. The bulkhead 14′ includes an annular channel 26′ formed therein. The annular flange 18′ of the bulkhead 14′ generally extends over at least a portion of the flapper door 24′.

As provided above in reference to FIG. 1, and now referring to FIG. 10, the annular seal 28′ is disposed in the filler pipe assembly 10′ between the bulkhead 14′ and the flapper door 24′. In an embodiment, the annular seal 28′ is situated in the filler pipe assembly 10′ such that at least a portion of the liquid/vapor sealing material 32′ is compressed between the flapper door 24′ and the bulkhead 14′, thereby forming a liquid/vapor seal between the bulkhead 14′ and the flapper door 24′. The flapper door 24′ may include an annular seat 40′ having a surface substantially defining a spherical zone that contacts the annular seal 28′. Without being bound to any theory, it is believed that the spherical zone annular seat 40′ provides enhanced sealing with greater tolerance to misalignment of the annular seal 28′ than linear or simple curved sealing surfaces. In an embodiment, the annular seal 28′ is crimped or otherwise disposed within the bulkhead 14′ to form a substantially liquid, vapor, and permeation proof joint between the annular seal 28′ and the bulkhead 14′. Furthermore, without being bound to any theory, it is believed that limiting the total area of the liquid/vapor sealing material portion 32′ that is exposed to liquid/vapor within the filler pipe assembly 10′, or to the atmosphere outside of the filler pipe assembly 10′, will substantially prevent the emission of hydrocarbon molecules to the atmosphere due to permeation. In an embodiment, the area exposed to the atmosphere outside of the filler pipe assembly 10′ is the edge of the liquid/vapor sealing material portion 32′ between the substantially impermeable material portion 30 and the flapper door 24′. It is to be understood that the liquid/vapor sealing material portion 32′ is at least partially compressed when the flapper door 24′ is closed, thereby leading to an additional reduction in the area of the liquid/vapor sealing material portion 32′ that is exposed to the atmosphere outside of the filler pipe assembly 10′.

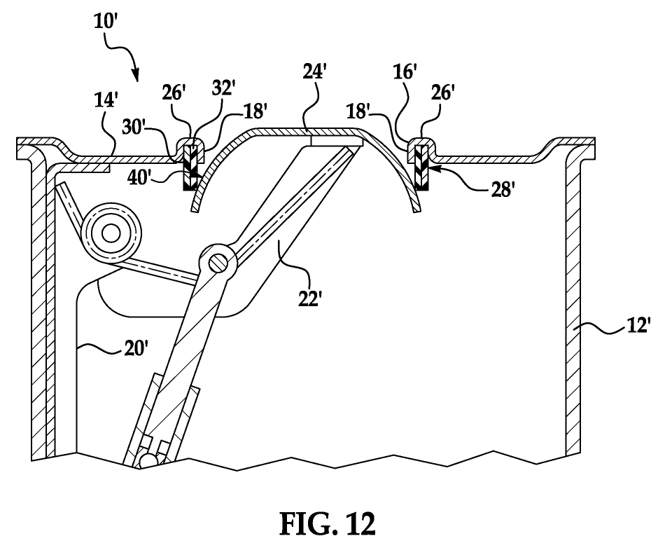

Referring now to FIG. 12, an embodiment of a capless fuel tank filler pipe assembly 10″ is shown. The capless fuel tank filler pipe assembly 10″ is similar to assembly 10′ shown in FIG. 10, except the annular seat 40″ is configured such that the annular seat 40″ contacts the annular seal 28″ on an inside diameter of the annular seal 28″ rather than on an outside diameter of the annular seal 28′ as shown in FIG. 10. It is to be understood that annular seat 40″ may include a surface substantially defining a spherical zone that contacts the annular seal 28′. In this embodiment, the liquid/vapor sealing material portion 32′ and the substantially impermeable material portion 30′ are diametrically reversed compared to the annular seal 28′ shown in FIG. 10, such that the liquid/vapor sealing material portion 32″ contacts the annular seat 40″ when the flapper door 24″ is closed.

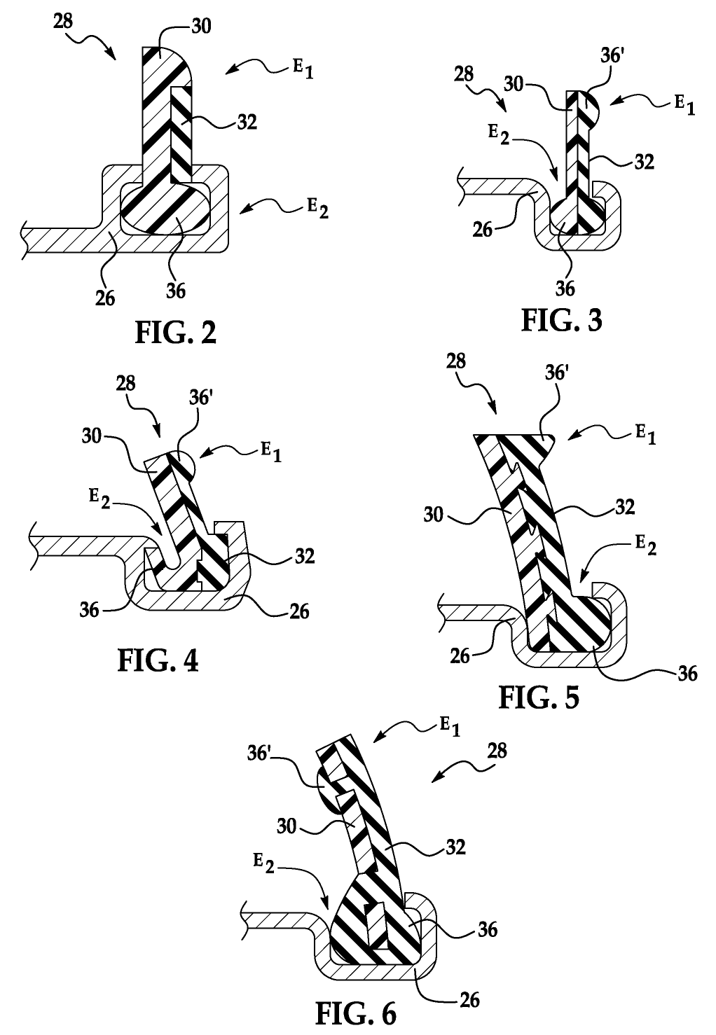

Various embodiments of the annular seal 28 are shown in FIGS. 2 through 8. While the annular seals 28 in these Figures are labeled similarly to the seals 28 shown in FIG. 1, it is to be understood that the embodiments of these seals 28 may be used in the embodiment of the assembly 10′ shown in FIG. 10. In each of the embodiments shown in FIGS. 2 through 7, the substantially impermeable material portion 30 is shown as a plastic material and the liquid/vapor sealing material portion 32 is shown as a rubber material. In the various embodiments depicted in FIGS. 2 through 7, the annular seal 28 is at least partially encapsulated by the channel 26 formed in a portion of the filler pipe assembly 10. It is to be understood, that the annular channel 26 may be formed in the flapper door 24, or the bulkhead 14′, as shown in FIG. 1 and FIG. 10, respectively.

FIGS. 2 through 6 depict embodiments of the seal 28 which include at least one annular protuberance 36. Generally, the annular protuberance 36 extends or projects outward at or near one end E₁, E₂ of the seal 28, but in some instances, additional protuberances 36′ are included at another end E₂, E₁ or at a desirable area along a length of the seal 28. The protuberances 36, 36′ are generally in the form of annular bulbs or annular barbs.

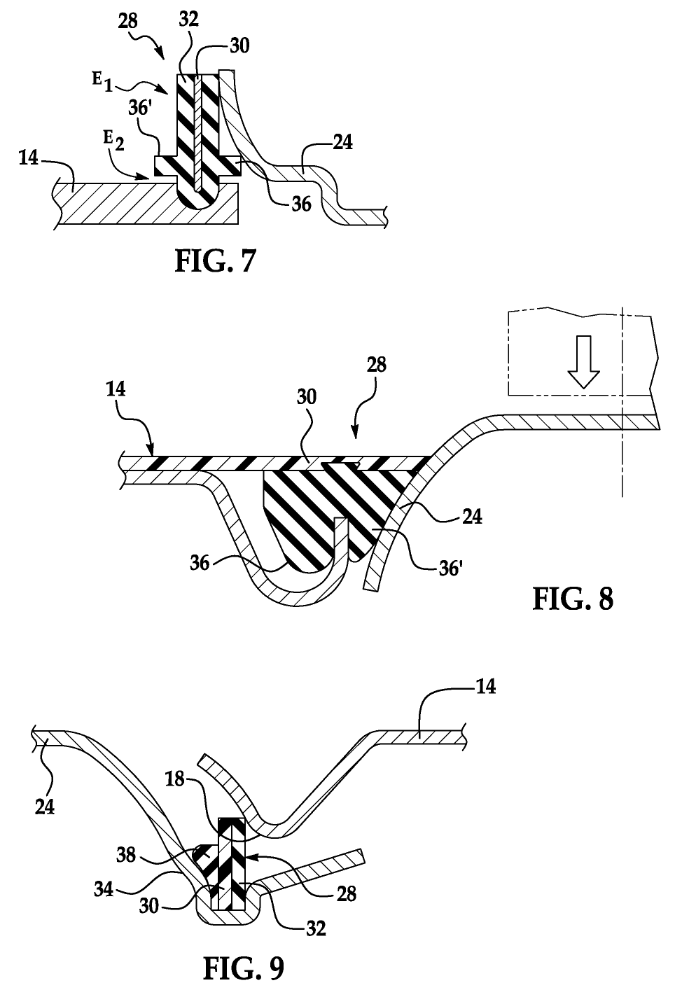

In an embodiment including one protuberance 36 (see, for example, FIG. 2), the protuberance 36 may be configured to contact the annular flange 18, the flapper door 24, or combinations thereof. In a non-limiting example, the flange 18 or flapper door 24 may include a C channel (shown in FIG. 7) that is configured to receive and hold at least a portion of the protuberance 36, 36′. In another non-limiting example, the channel 26 is configured to receive and hold at least a portion of the protuberance 36, 36′. In an embodiment including multiple protuberances 36, 36′, generally one of the protuberances 36 contacts the annular flange 18, and the other protuberance 36′ contacts the flapper door 24.

The embodiment shown in FIG. 2 includes an aperture formed in the liquid/vapor sealing material portion 32. The substantially impermeable material portion 30 is disposed such that it substantially fills this aperture.

The embodiment shown in FIG. 3 includes two annular protuberances 36, 36′, generally in the form of respective bulbs. One of the protuberances 36 is formed at one end E₂ of the seal 28 and extends from both portions 30, 32, and the other of the protuberances 36′ is formed at the other end E₁ of the seal 28 and extends from the portion 32.

The embodiment shown in FIG. 4 includes two annular protuberances 36, 36′, one 36 of which is in the form of a barb, and the other 36′ of which is in the form of a bulb. As shown in FIG. 4, the barb 36 is formed at one end E₂ of the seal 28 as part of portion 30, and the bulb 36′ is formed at the other end E₁ of the seal 28 as part of the portion 32. This embodiment also includes a relatively small aperture formed in the portion 30 where some of the portion 32 is disposed therein.

The embodiment of the seal 28 shown in FIG. 5 includes annular dovetails formed along the length of the seal 28 in the substantially impermeable material portion 30. These annular dovetails are interlocked with respective complementary annular dovetails formed in the liquid/vapor sealing material portion 32. This embodiment of the seal 28 may also include annular protuberances 36, 36′. As shown in FIG. 5, protuberances 36, 36′ extend, as part of the portion 32, from opposed ends E₁, E₂ of the seal 28.

The embodiment of the seal 28 shown in FIG. 6 includes at least a portion of the substantially impermeable material portion 30 extending through or interposed between apertures defined in the liquid/vapor sealing material portion 32. As shown in FIG. 6, annular protuberances 36, 36′ may also protrude from, for example, the substantially impermeable material portion 30 at opposed ends E₁, E₂ of the seal 28.

FIG. 7 illustrates an embodiment of the seal 28 including two annular protuberances 36, 36′ formed near one end E₂ of the seal 28. In this embodiment, the protuberance 36 extends directly from the end E₂ of the seal 28, and the other protuberance 36′ is positioned a spaced distance from the end E₂ along a length of the seal 28. A C channel is formed in the flange 14 such that it receives and holds at least a portion of the protuberance 36.

FIG. 8 illustrates an embodiment of the seal 28 including two annular protuberances 36, 36′. In the embodiment, a portion of the bulkhead 14 is interposed between the annular protuberances 36, 36′. The bulkhead 14, formed from a substantially impermeable material, substantially prevents exposure of the seal 28 to the atmosphere when the flapper door 24 compresses the seal 28. In the embodiment, a portion of the bulkhead 14 is mechanically bonded to the liquid/vapor sealing portion 32, thus serving both as a substantially impermeable portion 30 of the seal 28 as well as the bulkhead 14.

Referring now to FIG. 9, in an embodiment, a seal support flange 34 may be disposed adjacent to the annular seal 28 to act as a flexure stop for the annular seal 28. In the embodiment, a wear-stop band 38 may be disposed between the seal 28 and the seal support flange 34. Generally, the wear-stop band 38 is formed of a material that is harder and less subject to fuel swell or attack than may be portions of annular seal 28. FIG. 9 shows a semi-schematic representation depicting wear-stop band 38. In the embodiment, the wear-stop band 38 limits the deflection of annular seal 28, thereby reducing creep of the annular seal 28 after long term deflection from contacting bulkhead 14.

While several embodiments have been described in detail, it will be apparent to those skilled in the art that the disclosed embodiments may be modified. Therefore, the foregoing description is to be considered exemplary rather than limiting.

What is claimed is:

1. A capless fuel tank filler pipe assembly, comprising:
a filler pipe;
a bulkhead disposed on the filler pipe, the bulkhead including a nozzle receiving portion; and
a flapper door pivotally disposed on the filler pipe, the flapper door biased to a closed position and configured to compress an annular seal disposed between the bulkhead and the flapper door, the annular seal including a liquid/vapor sealing material bonded to a substantially impermeable material, wherein the substantially impermeable material substantially blocks emission of hydrocarbon molecules that permeate the liquid/vapor sealing material.

2. The capless fuel tank filler pipe assembly as defined in claim 1 wherein the liquid/vapor sealing material is a substantially resilient material having a substantially low permeability, wherein the substantially resilient material is a fluorinated elastomer selected from vinylidene fluoride, hexafluoropropylene, tetrafluoroethylene perfluoromethylvinylether, and combinations thereof.

3. The capless fuel tank filler pipe assembly as defined in claim 1 wherein the substantially impermeable material is selected from acetal, polytetrafluoroethylene, steel, aluminum, aluminum alloys, and combinations thereof.

4. The capless fuel tank filler pipe assembly as defined in claim 1 wherein the flapper door or the bulkhead includes an annular seat having a surface substantially defining a spherical zone configured to contact at least a portion of the liquid/vapor sealing material, the substantially impermeable material, or combinations thereof, thereby forming a seal.

5. The capless fuel tank filler pipe assembly as defined in claim 1, further comprising an annular flange formed about a periphery of the nozzle receiving portion or the flapper door, the annular flange having a surface configured to limit a deflection of the liquid/vapor sealing material, the substantially impermeable material, or combinations thereof.

6. The capless fuel tank filler pipe assembly as defined in claim 1 wherein the liquid/vapor sealing material, the substantially impermeable material, or combinations thereof includes at least one annular protuberance extending from at least one end of the annular seal.

7. The capless fuel tank filler pipe assembly as defined in claim 6 wherein the at least one annular protuberance is an annular barb or an annular bulb.

8. The capless fuel tank filler pipe assembly as defined in claim 6 wherein the bulkhead or the flapper door includes an annular channel configured to receive and hold at least a portion of the at least one annular protuberance.

9. The capless fuel tank filler pipe assembly as defined in claim 6 wherein the liquid/vapor sealing material, the substantially impermeable material, or combinations thereof further includes at least one other annular protuberance formed adjacent to the at least one annular protuberance, wherein the at least one other annular protuberance is configured to contact the bulkhead, the flapper door, or a combination of both.

10. The capless fuel tank filler pipe assembly as defined in claim 1 wherein the liquid/vapor sealing material is mechanically bonded to the substantially impermeable material, chemically bonded to the substantially impermeable material, or combinations thereof.

11. The capless fuel tank filler pipe assembly as defined in claim 10, further comprising:
at least one portion of the substantially impermeable material disposed into a respective aperture formed into the liquid/vapor sealing material;
at least one annular dovetail preformed in the substantially impermeable material and interlocked with a complementary annular dovetail formed in the liquid/vapor sealing material;
at least a portion of the substantially impermeable material interposed between at least two annular protuberances formed in the liquid/vapor sealing material; or
combinations thereof.

12. The capless fuel tank filler pipe assembly as defined in claim 1 wherein the annular seal is disposed between the bulkhead and the flapper door so that the liquid/vapor sealing material contacts the bulkhead, the flapper door, or both, thereby forming a seal therebetween.

13. The capless fuel tank filler pipe assembly as defined in claim 1 wherein exposure of the liquid/vapor sealing material to ambient air is substantially small when the annular seal is compressed between the bulkhead and the flapper door.

14. A method of sealing a capless fuel tank filler pipe assembly, comprising:
providing a filler pipe assembly including:
a bulkhead disposed thereon, the bulkhead including a nozzle receiving portion; and
a flapper door pivotally disposed on the filler pipe; and
selectively compressing an annular seal between the bulkhead and the flapper door, the annular seal including a liquid/vapor sealing material mechanically bonded, chemically bonded, or combinations thereof to a substantially impermeable material, wherein the substantially impermeable material substantially blocks emission of hydrocarbon molecules that permeate the liquid/vapor sealing material.

15. The method as defined in claim 14, further comprising:
forming an annular flange about the periphery of the nozzle receiving portion or the flapper door, wherein the annular flange includes an annular channel;
disposing and holding at least a portion of the annular seal in the annular channel; and
contacting the annular seal with the annular channel, the flapper door, or combinations thereof.

16. The method as defined in claim 15 wherein the annular flange includes a surface substantially defining a spherical zone, and the method further comprises:
contacting at least a portion of the liquid/vapor sealing material, the substantially impermeable material, or a combination of both with the surface substantially defining the spherical zone;
contacting at least a portion of the liquid/vapor sealing material, the substantially impermeable material, or a combination of both with the flapper door; or
combinations thereof.

17. A method of forming an annular seal for a fuel tank filler pipe assembly, the method comprising:
providing a liquid/vapor sealing material; and
mechanically bonding, chemically bonding, or combinations thereof a substantially impermeable material to the liquid/vapor sealing material, wherein the substantially impermeable material substantially blocks emission of hydrocarbon molecules that permeate the liquid/vapor sealing material.

18. The method as defined in claim 17 wherein mechanically bonding is achieved by:
disposing and holding at least one portion of the substantially impermeable material into a respective aperture preformed into the liquid/vapor sealing material;
forming at least one annular dovetail in the substantially impermeable material and interlocking the at least one annular dovetail with a complementary annular dovetail formed in the liquid/vapor sealing material;
interposing at least a portion of the substantially impermeable material between at least two annular protuberances formed in the liquid/vapor sealing material; or
combinations thereof.

19. The method as defined in claim 17 wherein chemically bonding is achieved by coextrusion, chemical adhesives, solvents, or combinations thereof.
